(19) United States
(12) Patent Application Publication
(10) Pub. No.: US 2006/0114495 A1
(43) Pub. Date: Jun. 1, 2006

(54) Printing system and method utilizing control by external central processing unit

(75) Inventor: William Pohl Corbett JR., Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/000,834

(22) Filed: Dec. 1, 2004

(51) Int. Cl. G06F 3/12

(52) U.S. Cl. 358/1.15

(57) ABSTRACT

Embodiments of the invention relate to a printing system and method in which a printer is controlled by an external personal computer (PC). In an embodiment, a method of printing comprises the acts of (a) receiving compressed tiles from a personal computer, the compressed tiles representing rectangles of data of a target page to be printed by a printer; (b) storing the received tiles in a memory as at least one band; (c) by a direct memory access (DMA) controller, providing the at least one stored band to a mechanism control unit; and (d) receiving, from the personal computer, memory and mechanism control information for the printer.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

Embodiments of the invention relate generally to printing systems and methods. More specifically, embodiments of the invention relate to a printing system and method utilizing control by an external central processing unit.

### BACKGROUND OF THE INVENTION

In some conventional laser printers, the raster image processor (RIP) in the printer produces bitmaps of planes and stores them in printer memory organized in tiles. A typical tile represents an area on the page to be printed that is 512 bits wide and 128 bits tall. Software in the printer then logically combines these tiles into bands to be printed by passing an instruction list to the printer ASIC (application-specific integrated circuit) via control registers for each plane. Data is gathered from printer memory, and a video signal is created for the printhead.

What is needed is an improved printing system and method that reduces manufacturing costs, yet does not sacrifice printing quality or throughput.

### SUMMARY OF THE INVENTION

The following summary sets forth certain example embodiments of the invention described in greater detail below. It does not set forth all such embodiments and should in no way be construed as limiting of the invention.

In an embodiment of the invention, a method of printing comprises the acts of (a) receiving compressed tiles from a personal computer, the compressed tiles representing rectangles of data of a target page to be printed by a printer; (b) storing the received tiles in a memory as at least one band; (c) by a direct memory access (DMA) controller, providing the at least one stored band to a mechanism control unit; and (d) receiving, from the personal computer, memory and mechanism control information for the printer.

In other embodiments of the invention, a method of printing involves receiving data from an external personal computer over an interface; determining the nature of the received data; sending the received data to the DMA controller if the received data is determined to be related to a write to the memory; and sending the received data to the mechanism control unit of the printer if the received data is determined to be related to a write to the mechanism control unit.

In another embodiment of the invention, a system for a printer comprises a data router, a mechanism control unit, and a DMA controller. The data router is configured to receive compressed tiles from a personal computer, the compressed tiles representing rectangles of data of a target page to be printed, and is further configured to receive memory and mechanism control information for the printer. The mechanism control unit is controllable based at least in part on the received mechanism control information. The DMA controller is configured to store the received tiles in a memory as at least one band and to provide the at least one stored band to the mechanism control unit. The memory controller is controllable based at least in part on the received memory control information.

### BRIEF DESCRIPTION OF THE DRAWINGS

FIG. 1 shows a system for a printer according to an embodiment of the invention.

FIG. 2 shows printer threads running within operating system memory of a personal computer according to an embodiment of the invention.

FIG. 3 shows a printer according to an embodiment of the invention.

FIG. 4 shows a printing process according to an embodiment of the invention.

FIG. 5 shows a printing process according to an embodiment of the invention.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The order of limitations specified in any method claims does not imply that the steps or acts set forth therein must be performed in that order, unless an order is explicitly identified in the specification as essential. In addition, it should be noted that a plurality of hardware and software based devices, as well as a plurality of different structural components, may be utilized to implement the invention.

Embodiments of the invention relate to a printing system and method in which a printer is controlled by an external personal computer (PC). The PC performs image processing (e.g., RIP—raster image processing) on behalf of the printer and sends control information (e.g., memory and mechanism control information) to the printer. Because image processing and control are performed externally, the printer need not include an on-board central processing unit (CPU). It is to be appreciated that such an architecture reduces manufacturing costs and complexities in the printer.

Although some specific examples below relate to mono laser printers, teachings herein can be applied to mono or color printers or to laser or inkjet printers. Additionally, the term “PC” is used generically herein to denote, for example, desktop computers, laptops, servers, and other computers that can be suitably configured to operate within the contexts broadly set forth herein. Further, embodiments of the invention can be applied to printers, copiers, scanners, facsimile devices, and combination or multifunction printers that perform some or all these functions. These devices are hereinafter collectively referred to as “printer” or “printer system.”

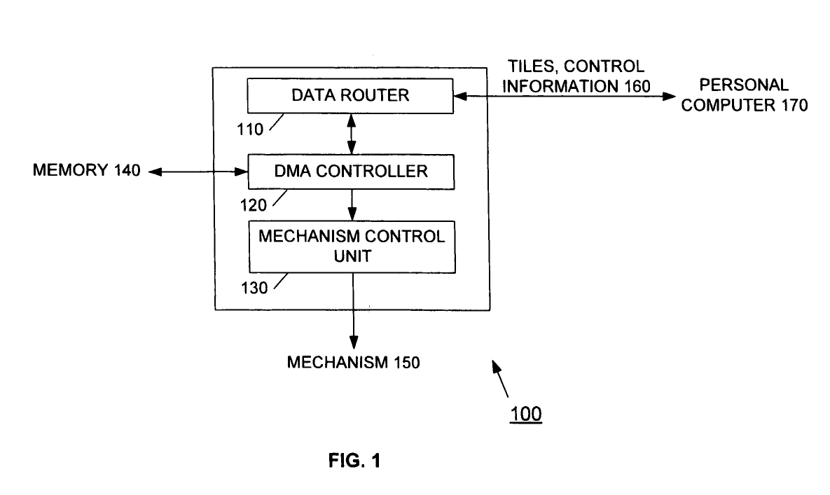

FIG. 1 shows a system 100 for a printer according to an embodiment of the invention. The system 100 includes a data router 110, a direct memory access (DMA) controller 120, and a mechanism control unit 130. The system 100 may be an application-specific integrated circuit (ASIC) that is resident within the printer and that interacts with other modules within the printer. Alternatively, one or more components of the system 100 may be implemented as discrete modules interfaced by suitable interfacing circuitry. In the embodiment shown in FIG. 1, the system 100 does not include a CPU.

The data router 110 receives information 160 from an external PC 170 and transmits information 160 to the PC 170. Such information 160 includes image data to be printed (e.g., compressed tiles), control data to control operation of modules in the system 100 and/or in the printer that contains the system 100, and printer identification and status information. The data router 110 determines the nature of the information 160 received by the data router 110. For instance, if the information 160 is image data, then that information 160 is routed to the DMA controller 120. If the information 160 is control information pertaining to a mechanism 150 (e.g., a laser) of the printer, that information is routed to the mechanism control unit 130 associated with the mechanism 150. The term “data router” used herein does not specifically implicate a “router” of a packet-switched network.

The DMA controller 120 stores image data in a memory 140. The DMA controller 120 can be implemented, for example, as a SDRAM (synchronous dynamic random access memory) controller or a DDR (double data rate) SDRAM controller. Additionally, the DMA controller 120 can provide image data to the mechanism control unit 130. The memory 140 can be implemented as DRAM (dynamic random access memory) or other suitable memory.

The mechanism control unit 130 controls operation of one or more mechanisms 150. In an embodiment, the mechanism control unit 130 includes a laser scanning control unit, and the mechanism 150 includes a laser.

In an embodiment of the invention, an external PC that controls a printer has one or more threads running in operating system memory. Such thread(s) prepare print jobs for printing (e.g., perform image processing), send the prepared data to the printer, and send memory and mechanism control information to the printer.

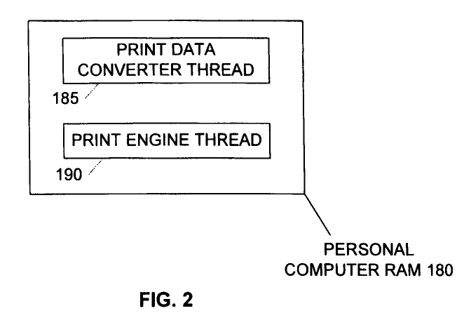

FIG. 2 shows printer threads running in operating system RAM 180 of a Windows-based PC according to an embodiment of the invention. As shown, a print data converter thread 185 and a print engine thread 190 are resident in RAM 180. Although two printer threads are shown in FIG. 2, the services provided by the printer threads 185, 190 can be implemented in different ways and in different operating systems in accordance with the art. For instance, one or more application programs can be executed in place of one or more of the printer threads described herein.

The print data converter thread 185 converts a job to be printed into compressed tiles representing rectangles of data on the final printed page. The print data converter thread 185 renders the tiles such that a band can be constructed in the printer's DRAM memory pool when the tiles are sent to the printer. For instance, the rendered tiles can be 128 scan lines in height with a width corresponding to the width of the page to be printed (e.g., 23,000 bits). The print data converter thread 185 sends the rendered tiles across the Windows Device Manager (WDM), which in turn sends the tiles across an appropriate interface to be placed in memory of the printer as a band and then printed.

The print engine thread 190 maintains a print engine remotely over an interface (e.g., a USB interface) between the PC and the printer. For example, the interface between the PC and the printer can be a full-speed USB interface or a high-speed link. A full-speed link can allow for 12 megabits of data transferred per second and an interrupt packet interval of 1 millisecond. A high-speed link can transfer information at 480 megabits per second and has an interrupt packet interval of approximately 116 microseconds per packet.

In an embodiment, a printer provides for an interface that allows 512 bytes of register space. The print engine thread 190 manipulates the bytes to control the mechanism and memory information for the printer. The interactions between the various software and hardware controlling the print mechanism(s) of the printer can be automated to optionally allow all the registers inside the printer to be accessed both for a single read and a single write transaction once every 10 milliseconds. If a portion of an image rasterized by the print data converter thread 185 contains no data, then the threads 185, 190 do not have to transfer any data to the printer. In general, there is no need to transfer data for an entire printed page because documents typically include blank areas or tiles.

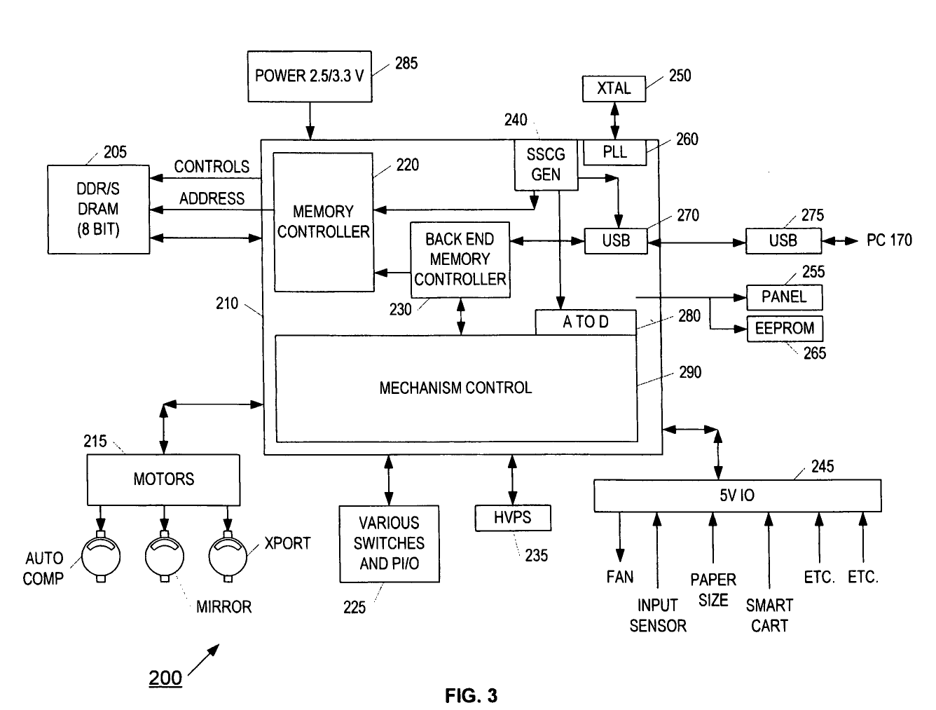

FIG. 3 shows a printer 200 according to an embodiment of the invention. The printer 200 includes a print subsystem 210, a power source 285, a crystal 250, a USB port 275, a panel 255, an EEPROM 265, an input/output portion 245, a high voltage power supply (HVPS) 235, a switches and input/output portion 225, a motor system 215, and DRAM 205. The implementation shown in FIG. 2 is merely an example. Consistent with the teachings herein, other implementations can be made by a person of ordinary skill in the art.

The print subsystem 210 includes a memory controller 220, a back end memory controller 230, a spread spectrum clock generator (SSCG) 240, a phase locked loop (PLL) 260, a USB interface module 270, an analog-to-digital (A/D) converter 280, and a mechanism control unit 290. In an embodiment, one or more components of the print subsystem 210 are implemented as an ASIC.

In an example embodiment, the crystal 250 has a frequency of 25 MHz. The SSCG 240, in conjunction with the crystal 250 and the PLL 260, generates a 240 MHz clock for the USB interface, and a 433 MHz clock for the print subsystem 210.

The printer 200 is connected to an external PC 170 via a USB interface. The USB framework allows for endpoints that can be configured in the discovery phase of a newly attached link. Information about whether data will be read or written through an endpoint, the amount of data allowed, and how often to access the endpoint are example details determined during an enumeration or discovery phase.

Specifically, the USB port 275 and USB interface module 270 enable a connection between the printer 200 and the PC 170. Various types of data are communicated between the printer 200 and the PC 170, including image (bitmap) information for a page to be printed, memory control information to control operation of the memory controller 220, mechanism control information to control operation of the mechanism control unit 290, and USB descriptors, such as device, configuration, and interface descriptors. In an embodiment, when the printer 200 is powered on, the PC 170 queries the printer 200, which responds with necessary descriptors to allow the PC 170 to recognize and communicate with the printer 200. Once recognized, four endpoints are enumerated for the printer 200: write to DRAM, read from DRAM, write to mechanism control, and read from mechanism control.

The USB module 270 presents data from the PC 170 to the back end memory controller 230. In an embodiment, the back end memory controller 230 is device-agnostic, providing a standard interface for data originating from a PC running appropriate threads, and for data originating from the memory controller 220 or the mechanism control unit 290. The back end memory controller 230 determines whether data should be written to, or read from, the DRAM 205, or whether data should be written to, or read from, the mechanism control unit 290. If data should be written to the DRAM 205, then the data is passed to the memory controller 220, which may be an SDRAM or DDR (double data rate) controller, for example. On the other hand, if data is control information to govern operation of the mechanism control unit 290 (to control, e.g., a laser control unit or other print modules that may be external to the print subsystem 210), such data is transferred from the back end memory controller 230 to the mechanism control unit 290 so that appropriate action can be taken.

The memory controller 220 has a direct memory access unit to directly transfer data from the DRAM 205 to the mechanism control unit 290 to be printed. In an embodiment of the invention, the memory controller 220 employs a banding structure, wherein an entire page to be printed is placed in the DRAM 205 memory pool of the memory controller 220 as one or more bands. The memory controller 220 then can walk through the band linearally to provide the data for printing. The memory controller 220 includes a clear behind serializing DMA unit that fetches bit patterns to be printed and then zeros out DRAM 205 to leave a cleaned band. In particular, the memory controller 220 fetches a block of data from DRAM 205 in 512 byte chucks and then serializes or shifts out the raw data to the mechanism control unit 290 one bit at a time.

If desired, a FIFO (not shown) can be provided between the memory controller 220 and the mechanism control unit 290. Such a FIFO can manage the buffering of the serialized data to allow other transactions to occur that involve the DRAM 205. In addition, such a FIFO can be chosen to be sufficiently deep to ensure that data is always available for the mechanism control unit 290 at any given time. Once a 512 byte chunk of data has been saved in the FIFO, the data that was in DRAM 205 is zeroed out so that a thread running on the PC (e.g., the print engine thread 190 of FIG. 2) can determine that there is a zeroed state in memory.

The serializing DMA unit of the memory controller 220 can work on a band in DRAM 205 one at a time. Once a current band is completed, the next band is updated so that it can be operated upon. Once an entire page has been sent to be printed, the printer gear that registers for the consecutive page adjusts for the next page and begins serializing with the newly initiated serializing DMA unit. The serializing DMA unit can manipulate bits of data in the DRAM 205 before sending the data to the FIFO. For instance, the DMA unit can expand the data in the scanning direction and serialize the data to the mechanism control unit 290 in a duplex fashion.

In an embodiment, two sets of registers in the DRAM 205 are loaded and maintained by printer thread(s) of the PC 170. Each set of registers comprises an address pointer in the DRAM 205 where a band begins, a directional bit, and an indication of the length in bytes of the band. This information is used by the DMA unit of the memory controller 220. There can be two sets of such registers to enable the software to initialize the next band DMA while a current band DMA is operating. Thus, the PC 170 can have a complete band time in which to initialize the next DMA operation. An example band time for a system is approximately 30 milliseconds.

The DRAM 205 can be sufficiently large to enable multiple pages to be buffered in the printer at any given time. Once enough of the image data for a print job is downloaded to the DRAM 205, a DMA unit of the memory controller 220 is launched to print the bands of data stored in the DRAM 205 to the mechanism control unit 290 (e.g., the laser scanning unit).

In an embodiment, the print system 210 is configured for various systems, including, for example, band list DMA, laser scanning control, print area control, mirror motor speed, transport motor speed, high voltage power supply PWM (pulse width modulation) outputs, fuser control, and various sensors.

The laser scanning control unit, if provided in the printer 200, maintains when the laser of the printer 200 is turned on and off and also aligns the laser to the paper. Once initialized, the laser scanning control unit may be maintenance-free for multiple pages, with its operation being dependent upon the speed of the mirror motor, the speed of the paper path, and the physical characteristics of the paper and lens through which the laser moves. The laser scanning control unit may also set the power level for the laser as well as divide up the laser scan path into zones.

Each page to be printed may have unique registration requirements. Appropriate modules in the printer 200 can control how a page is registered from a top, left, and right margin on a page. Registers in the printer 200 may be set once for each page printed.

The mirror motor speed (see motor system 215 of FIG. 3) can be controlled in one embodiment by a set of three registers that take in a fundamental fixed frequency clock and divide the clock down into roughly a 20 kHz clock signal. This signal when operating causes the mirror motor to spin at a certain velocity and remain at that velocity for multiple pages. It is to be appreciated that very little maintenance is required to control such system.

The transport motor system (see motor system 215 of FIG. 3) can involve a stepper motor, wherein software directs operation of the stepper with a 30 millisecond or higher interval rate. In an embodiment in which a DC motor is selected to control the paper path system, the maintenance can be similar to mirror motor maintenance requirements.

The mechanism control unit 290 can include PWM outputs (not shown) that control such devices as the HVPS 235. The PWM outputs are typically configured and change multiple times through a printed page. Devices controlled by the PWM outputs also can involve the charge, transfer, and developer supplies that handle collecting and transferring toner from the toner cartridge to a piece of paper. In an embodiment, the maintenance of these devices, although multiple changes per page, is no more than one change every 300 milliseconds.

The fuser system (not specifically shown) of the printer 200 can be maintained at a regular interval. The temperature is continuously checked and adjusted based on the type of media being printed upon and the rate at which the media is passing through the fuser. In an implementation, the mechanism controller 290 does not need to make any adjustments any more often than once every 30 milliseconds.

In an embodiment, the mechanism maintenance interval for the printer 200 is 60 kbytes per second (interrupt data). The bandwidth of a high-speed USB host interface with multiple devices attached and active transfer of data is sufficiently high to sustain a printer running at 32 pages per minute and printing 1,200 DPI pages. To ensure proper functioning of the printer 200, the mechanism control has a regular interval in which to get information back and forth across the USB interface in order to sustain the printing processes. This interval is guaranteed because an interrupt endpoint is used through which to transfer data. Additionally, the size of the DRAM 205 is chosen to be high enough to ensure that irrespective of the load and data bandwidth being consumed by attached USB devices, an entire bitmap of a page to be printed is present in the printer DRAM 205 before the page is printed, and thus that a job being printed will be timely completed.

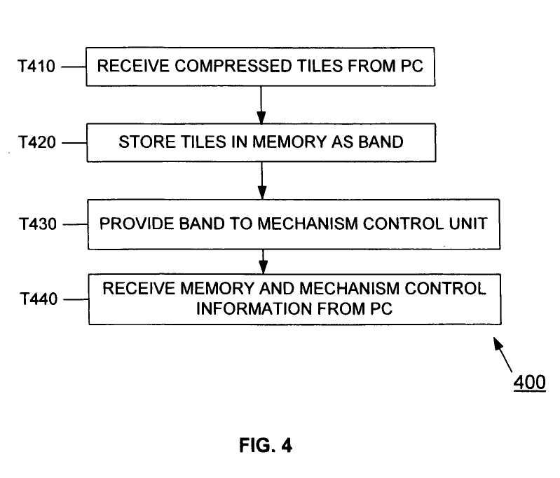

FIG. 4 shows a process 400 according to an embodiment of the invention. The process 400 relates to the banding methodology employed in the present invention and described above. The process 400 may be employed by, for example, the systems shown in FIGS. 1 and 3. Task T410 receives compressed tiles from an external PC. Task T420 stores the tiles in printer memory as a band. Task T430 provides the band to a mechanism control unit (e.g., a laser scanning control unit). Task T440 receives memory and mechanism control information from the external PC.

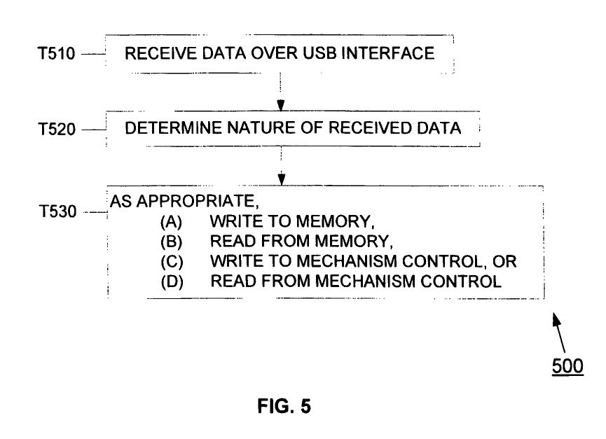

FIG. 5 shows a process 500 according to an embodiment of the invention. The process 500 can be performed by, for example, the data router 110 and back end memory controller 230 shown in FIGS. 1 and 3 respectively. Task T510 receives data over a USB interface. Task T520 determines the nature of the received data, such as whether the data is image data or control data. Task T530, as appropriate, writes data to memory, reads data from memory, writes data to mechanism control, or reads data from mechanism control.

Alternative embodiments of the invention can be realized. For instance, a printer with an architecture in accordance with the invention can include an on-board CPU that provides user functions unrelated to image processing and control functions specifically performed by an external PC. Accordingly, such a printer can economically provide a wider array of functions to a user.

As should also be apparent to one of ordinary skill in the art, the systems shown in the figures are models of what actual systems might be like. As noted, many of the modules and logical structures described are capable of being implemented in software executed by a microprocessor or a similar device or of being implemented in hardware using a variety of components including, for example, ASICs. Terms like “processor” may include or refer to both hardware and/or software. Furthermore, throughout the specification capitalized terms are used. Such terms are used to conform to common practices and to help correlate the description with the coding examples and drawings. However, no specific meaning is implied or should be inferred simply due to the use of capitalization. Thus, the claims should not be limited to the specific examples or terminology or to any specific hardware or software implementation or combination of software or hardware.

Various features and advantages of the invention are set forth in the following claims.

What is claimed:

1. A method of printing comprising the acts of:
receiving compressed tiles from a personal computer, the compressed tiles representing rectangles of data of a target page to be printed by a printer;
storing the received tiles in a memory as at least one band;
by a direct memory access (DMA) controller, providing the at least one stored band to a mechanism control unit; and
receiving, from the personal computer, memory and mechanism control information for the printer.

2. The method of claim 1, wherein the mechanism control unit comprises a laser scanning control unit.

3. The method of claim 1, wherein the printer lacks a central processing unit.

4. The method of claim 1, wherein a thread running on the personal computer is configured to convert print data into the compressed tiles.

5. The method of claim 1, wherein a thread running on the personal computer is configured to remotely maintain a print engine, the print engine being configured to manipulate control bits associated with the control information.

6. The method of claim 1, wherein the printer and the personal computer communicate over a high-speed link.

7. The method of claim 1, wherein the printer and the personal computer communicate over a USB interface.

8. The method of claim 1, wherein the memory includes DRAM.

9. The method of claim 8, wherein the DMA controller is configured to retrieve stored data from DRAM and provide the retrieved data to the mechanism control unit.

10. The method of claim 9, wherein the retrieved data is buffered before being provided to the mechanism control unit.

11. The method of claim 9, wherein the DMA controller retrieves the stored data from DRAM in 512 byte portions.

12. The method of claim 9, wherein the DMA controller provides the retrieved data to the mechanism control unit one bit at a time.

13. The method of claim 9, wherein the DMA controller zeroes out the stored data in DRAM after the stored data is retrieved.

14. The method of claim 1, wherein data is received from the personal computer over an interface, the method further comprising the acts of:
determining the nature of the received data;
sending the received data to the DMA controller if the received data is determined to be related to a write to the memory; and
sending the received data to the mechanism control unit if the received data is determined to be related to a write to the mechanism control unit.

15. The method of claim 1, wherein the printer is a mono printer.

16. A system for a printer, the system comprising:
a data router configured to receive compressed tiles from a personal computer, the compressed tiles representing rectangles of data of a target page to be printed, the data router further configured to receive memory and mechanism control information for the printer;
a mechanism control unit controllable based at least in part on the received mechanism control information; and
a direct memory access (DMA) controller configured to store the received tiles in a memory as at least one band and provide the least one stored band to the mechanism control unit, the memory controller being controllable based at least in part on the received memory control information.

17. The system of claim 16, wherein the data router comprises a back end memory controller.

18. The system of claim 16, wherein the mechanism control unit comprises a laser scanning control unit.

19. The system of claim 16, wherein the printer lacks a central processing unit.

20. The system of claim 16, wherein components of the system are contained on an ASIC in the printer.

21. The system of claim 16, further comprising a buffer configured to temporarily store data being provided to the mechanism control unit by the DMA controller.

22. The system of claim 16, wherein a thread running on the personal computer is configured to convert print data into the compressed tiles.

23. The system of claim 16, wherein a thread running on the personal computer is configured to remotely maintain a print engine, the print engine being configured to manipulate control bits associated with the control information.

24. The system of claim 16, wherein the printer and the personal computer communicate over a high-speed link.

25. The system of claim 16, wherein the printer and the personal computer communicate over a USB interface.

26. The system of claim 16, wherein the memory includes DRAM.

27. The system of claim 26, wherein the DMA controller is configured to retrieve stored data from DRAM and provide the retrieved data to the mechanism control unit.

28. The system of claim 27, wherein the DMA controller is configured to retrieve the stored data from DRAM in 512 byte portions.

29. The system of claim 27, wherein the DMA controller is configured to provide the retrieved data to the mechanism control unit one bit at a time.

30. The system of claim 27, wherein the DMA controller is configured to zero out the stored data in DRAM after the stored data is retrieved.

31. The system of claim 16, wherein data is received from the personal computer over an interface, and the data router is further configured to determine the nature of the received data, to send the received data to the memory controller if the received data is determined to be related to a write to the memory, and to send the received data to the mechanism control unit if the received data is determined to be related to a write to the mechanism control unit.

32. The system of claim 16, wherein the printer is a mono printer.

33. A computer-readable medium encoded with a plurality of processor-executable instructions for:
receiving compressed tiles from a personal computer, the compressed tiles representing rectangles of data of a target page to be printed by a printer;
storing the received tiles in a memory as at least one band;
by a direct memory access (DMA) controller, providing the at least one stored band to a mechanism control unit; and
receiving, from the personal computer, memory and mechanism control information for the printer.
